(19) United States
(12) Patent Application Publication
(10) Pub. No.: US 2008/0183634 A1
(43) Pub. Date: Jul. 31, 2008

(54) SYSTEMS AND METHODS FOR MANAGING MATERIAL TRANSACTIONS

(76) Inventor: L. Sean SADLER, Export, PA (US)

Correspondence Address: REED SMITH LLP, P.O. BOX 488, PITTSBURGH, PA, 15230-0488, US

(21) Appl. No.: 12/016,891

(22) Filed: Jan. 18, 2008

Related U.S. Application Data
(60) Provisional application No. 60/881,055, filed on Jan. 18, 2007.

(51) Int. Cl. G06Q 10/00; G06Q 30/00

(52) U.S. Cl. 705/80; 705/34; 705/37; 705/1

(57) ABSTRACT

Systems and methods for managing material inventories and invoices. Specifically, a computer-based system for managing materials from multiple locations and standardized tracking of materials and invoices. The present invention preferably allows for material inventory tracking, generation of standardized bids and offers to purchase materials, generation of invoices, and tracking of invoices.

### CROSS-REFERENCE TO RELATED APPLICATION

This application claims the benefit under 35 U.S.C. § 119(e) of the earlier filing date of U.S. Provisional Application Ser. No. 60/881,055 filed on Jan. 18, 2007.

### BACKGROUND OF THE INVENTION

Many modern recyclables generators use methods adopted prior to the computer era. Once a recyclable product is generated, the generator may collect the material in an appropriately sized receptacle, not accounting for material weights or specific material grades. The generator then may contact a recyclables vendor. In most cases the vendor is located locally, within the same geographic region. The generator may allow the material to ship, relying on the vendor to provide material grades, material values or costs, material weights, other relevant information, or all of the above. Frequently, the generator will record these unverified datum using generic spreadsheet applications or hand written documents containing minimal, and often irrelevant data.

Thus, there has been a long standing need in the industry for a standardized tool to efficiently manage recyclable material documentation, inventories and sales throughout the entire recyclables life cycle. The present invention solves these problems, giving recyclables generators access to materials values and specifications, access to markets, multiple location control over records, and multiple location control over the bidding process with known clientele or system-provided vendors. The potential for integration with weighing devices, or spectrometers that yield exact grades or chemical compositions, will close the unverified datum gap often experienced by generators. The present system may also be potentially integrated with barcode scanners and photo identification devices to secure data and streamline data handling.

### SUMMARY OF THE INVENTION

The present invention relates generally to systems and methods for managing, selling, and buying materials. More specifically, the present invention provides a comprehensive online system that may be useful for the management of recyclable materials. The present invention may allow for standardized and efficient tracking of material inventories over multiple locations, creation and tracking of invoices, market research regarding material values and grades, creation of bids, access to markets, and management of offers to purchase materials.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows an exemplary welcome page providing links to various possible modules of the present invention;

FIG. 2 shows an exemplary page providing links for managing material inventories and invoices;

FIG. 3 shows an exemplary list of inventory grouped by material subcategory;

FIG. 4 shows an exemplary page for entering data to create an invoice;

FIG. 5 shows an exemplary page listing saved vendor information;

FIG. 6 shows an exemplary page listing inventory items;

FIG. 7 shows an exemplary page for entering price and quantity information for an invoice;

FIG. 8 shows an exemplary page for entering additional information for an invoice;

FIG. 9 shows an exemplary “Snap Shot” page summarizing inventory and invoice information;

FIG. 10 shows an exemplary page listing weekly material values;

FIG. 11 shows an exemplary graph of historical material values;

FIG. 12 is a chart showing a preferred login and access scheme;

FIG. 13 is a chart showing a preferred material and inventory tracking module;

FIG. 14 is a chart showing a preferred material valuation module;

FIG. 15 is a chart showing a preferred bid generation module; and

FIG. 16 is a chart showing a preferred module for finding potential material buyers.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. The detailed description will be provided herein below with reference to the attached drawings.

The present invention relates generally to computer-based methods and systems for efficient management of material inventories and transactions. The present invention may be particularly useful for managing recyclable and reusable materials such as metals, plastics, paper, or glass. It is understood that the systems and methods of the present invention also could be applied to the management of a wide variety of other materials.

For purposes of this description, the term “user” is generally used to refer to someone who employs the present invention to manage material inventory or sell materials, while the term “vendor” is generally used to refer to someone who uses the present invention to make offers to purchase or to purchase materials. A “user” may also be a “vendor.”

An online system may allow users to manage material inventories over multiple locations, organize inventory using various criteria, and track daily inventory accumulation of those materials. Specific packages may be documented with inventory tracking information. The system may also provide standardized tracking that simplifies material documentation processes and provides a tool for easy input at the material source.

The present invention may further provide a standardized bidding process for users to sell materials. The system may allow for electronic invitations to bid and standardized offers to purchase materials. The system may allow a user to select vendors to invite to bid on materials, or the system may provide a database of vendors for a user to find potential buyers. The system may also allow generation of invoices and packing lists, and may allow management of invoices and other transaction information. Further, the system may provide valuable market research for use in determining appropriate values and grading for materials.

In at least one preferred embodiment of the present invention, a user's information may be stored and accessed securely through the use of a unique username and password. A user may use the system to manage inventory of recyclable materials.

### Tracking Materials and Invoices

For example, a user may track material inventory. The present invention may allow a user to manage an inventory of materials over multiple locations and track daily inventory accumulation of those materials by storing data regarding such materials. The present invention may provide a standardized tracking method that simplifies the documentation process for materials. Specific packages may be documented with inventory tracking information. The system preferably provides a standardized tracking method for material documentation that allows input of information at the material source. The present invention preferably allows a user to view material inventories over multiple locations in real time, and also allows sorting and searching of the information by various user-defined and flexible criteria. The present invention further may allow use of such information to create and track invoices.

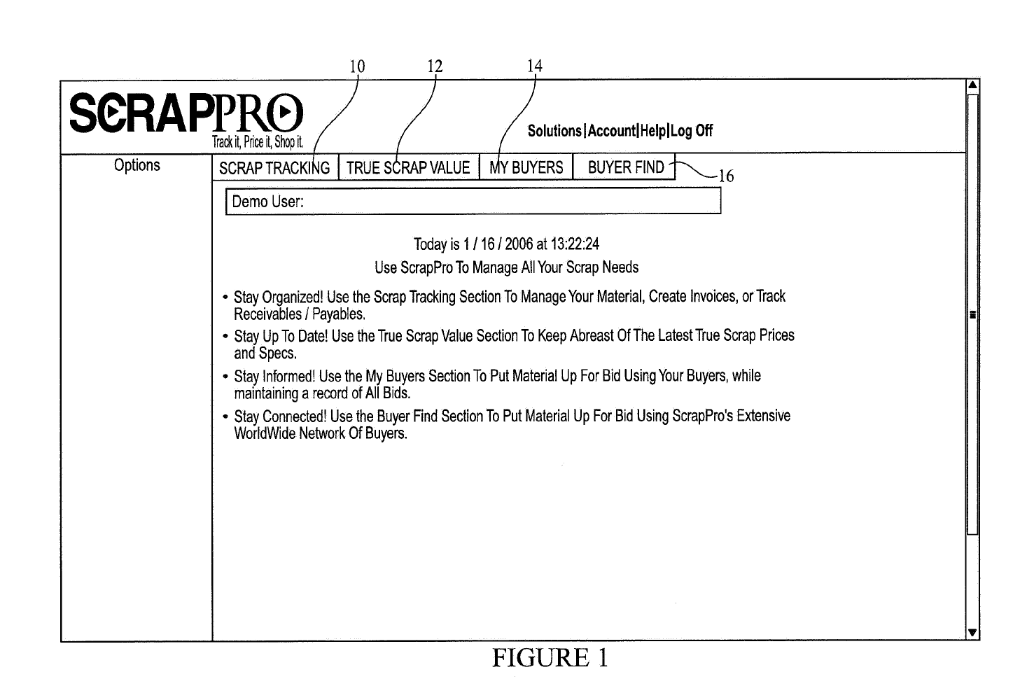

One preferred embodiment of the present invention provides a welcome page after the user logs in to the system. An exemplary welcome page is shown in FIG. 1.

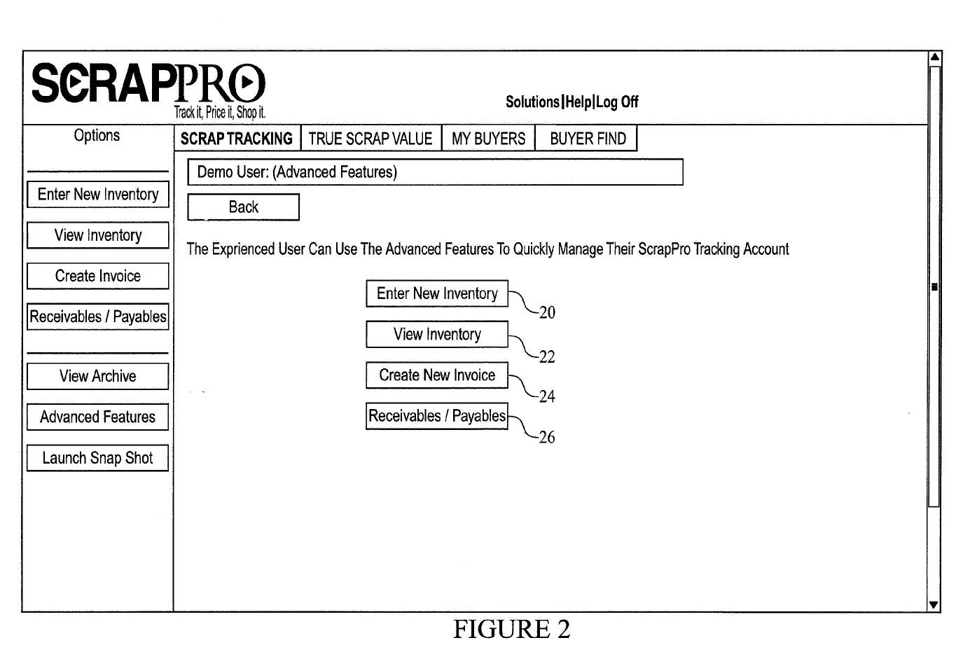

The welcome page provides links to various modules, including a “Scrap Tracking” link 10 to a material inventory and invoice tracking module. As shown in FIG. 2, the user may then click on “Enter New Inventory” link 20 to access a page that allows the user to enter information about a new inventory item.

A typical user of the system may be any generator of recyclable materials. Such generators include manufacturers, machinists, government, health care providers, retailers, industrial service providers, municipalities, demolition service providers, salvagers, non-profit organizations, and scrap vendors. As a user generates new inventory items, the user may enter information about individual inventory items into the system. The user may use that information to organize or search inventory, or to create invoices. That information may include the type of material, job name, package type, gross weight, tare weight, net weight, and inventory identification number. The system optionally may be configured to automatically calculate the net weight of the material by calculating the difference between the gross weight and tare weight entered by the user. The system may also allow for automatic generation of inventory identification numbers. The system may also provide for additional data fields for entry of information regarding inventory items. Further, the system may be configured to allow user entry of additional comments or information according to the user's wishes. Additionally, data may be directly entered into the system through an interface with a variety of electronic devices, such as a scale, spectrometer, barcode scanner, or photographic recognition device.

The data fields employed by the present invention for the type of material may be classified on multiple levels. For example, a three-tiered classification system might include a general material field (e.g., metal, paper), a material type field (e.g., aluminum, cardboard), and a material subcategory field describing the specific inventory items (e.g., cans, folded boxes). In one preferred embodiment of the present invention, a user may save material subcategories for later use to provide standardized categorization of inventory items. Information entered into other fields may similarly be saved for future use. A user, for example, may save a job name for use with a job expected to generate multiple inventory items.

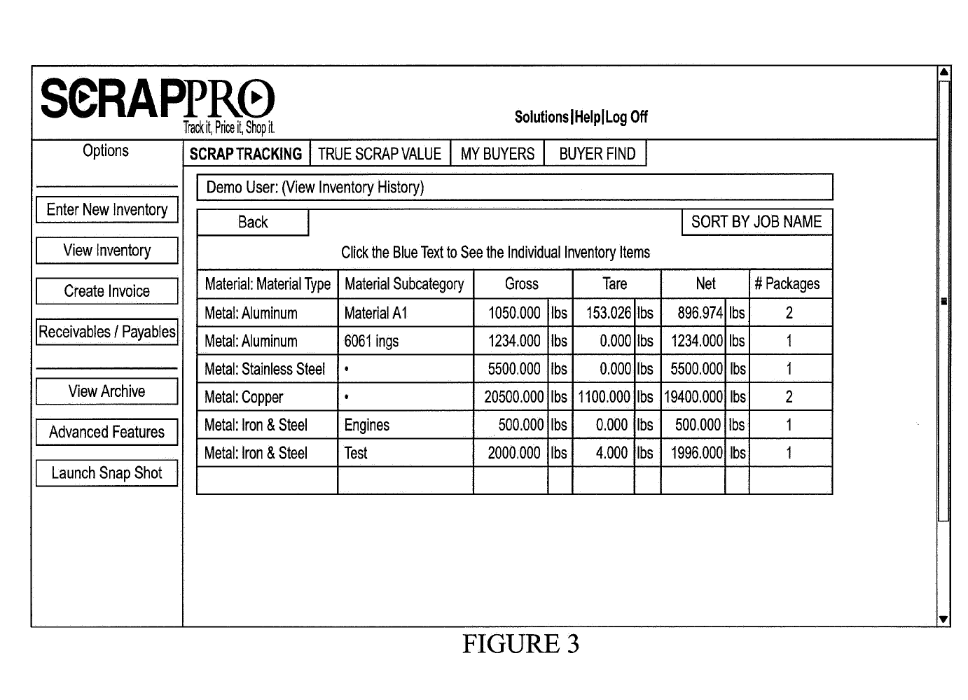

The present invention may also allow a user to view inventory entered into the system. Referring again to FIG. 2, one presently preferred embodiment of the present invention provides a “View Inventory” link 22 that allows a user to access a page showing inventory items. Inventory may be sorted based on information entered in the data fields described above. For example, inventory items might be sorted by material, material type, or material subcategory. FIG. 3 displays an exemplary list of inventory items grouped by material subcategory. In the preferred embodiment shown in FIG. 3, the present invention calculates the total gross, tare, and net weights for all inventory items within each material subcategory and displays a list of material subcategories showing those total weights. The system may further provide a hypertext link for each material subcategory that links to a page showing a list of individual inventory items for each subcategory. Similarly, a user might choose to group inventory items by job name or view a list of all inventory items associated with a particular job name. The system may also allow a user to print or edit inventory information from the “View Inventory” page.

The present invention may also allow a user to generate a variety of queries to sort and organize information. The present invention may be configured to calculate the number of inventory items meeting certain criteria entered by a user (e.g., number of items over a certain weight or number of items of a particular material type), or perform other queries based on the information entered. Using the various inventory item data fields, a variety of customized displays may be generated based on different queries. For example, a user might select how to group inventory items and what data fields to display. A user may also simply choose to view an itemized list of all inventory items.

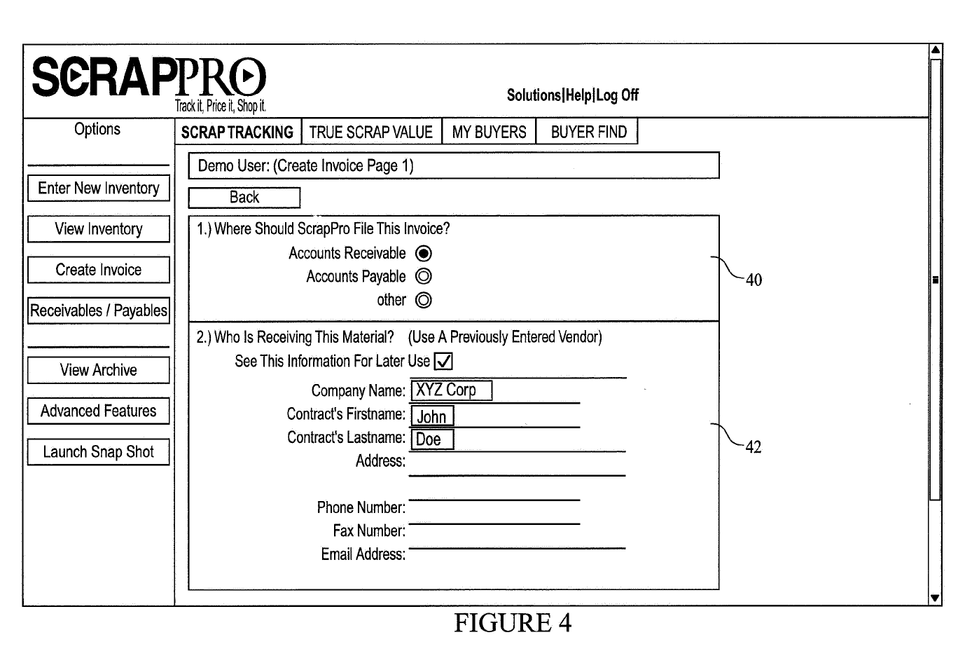

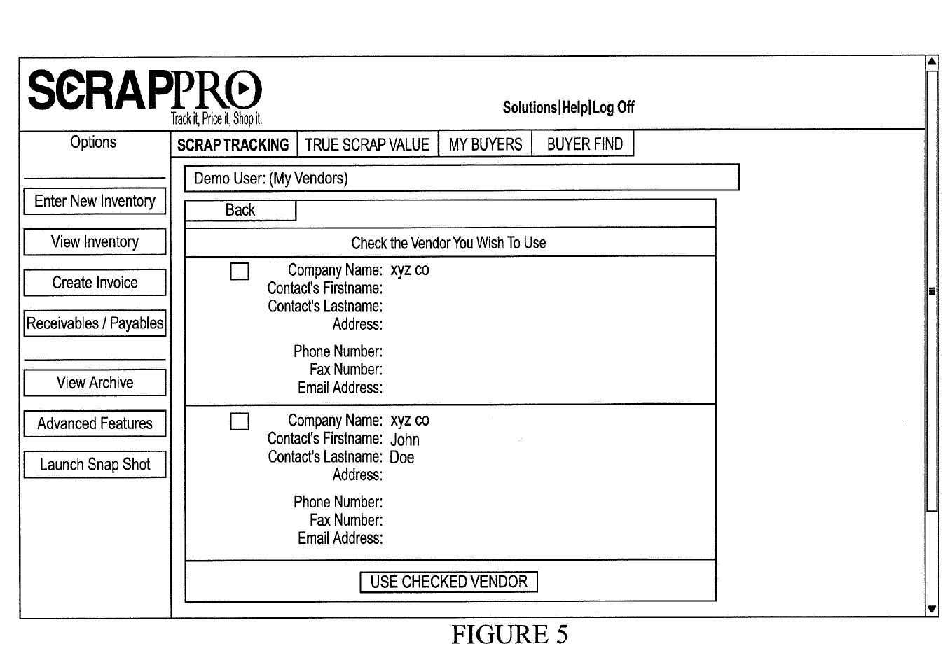

The present invention may also be used by a user to generate invoices and packing lists for inventory items. The present invention preferably provides a standardized invoicing method to streamline material invoicing procedures. Referring again to FIG. 2, one preferred embodiment of the present invention provides a “Create New Invoice” link. As shown in FIG. 4, after selecting the link, the user selects whether the invoice should be filed under accounts receivable, accounts payable, or other 40. The user then enters the vendor's contact information, such as company name, contact person name, address, phone number, fax number, and e-mail address 42. The system may also allow the user to store vendor information and select previously entered information. The present invention may, for example, provide a “Use A Previously Entered Vendor” link that provides access to a list of previously entered vendors as shown in FIG. 5. The user may then select a vendor to have that vendor's information automatically entered into the invoice or packing list.

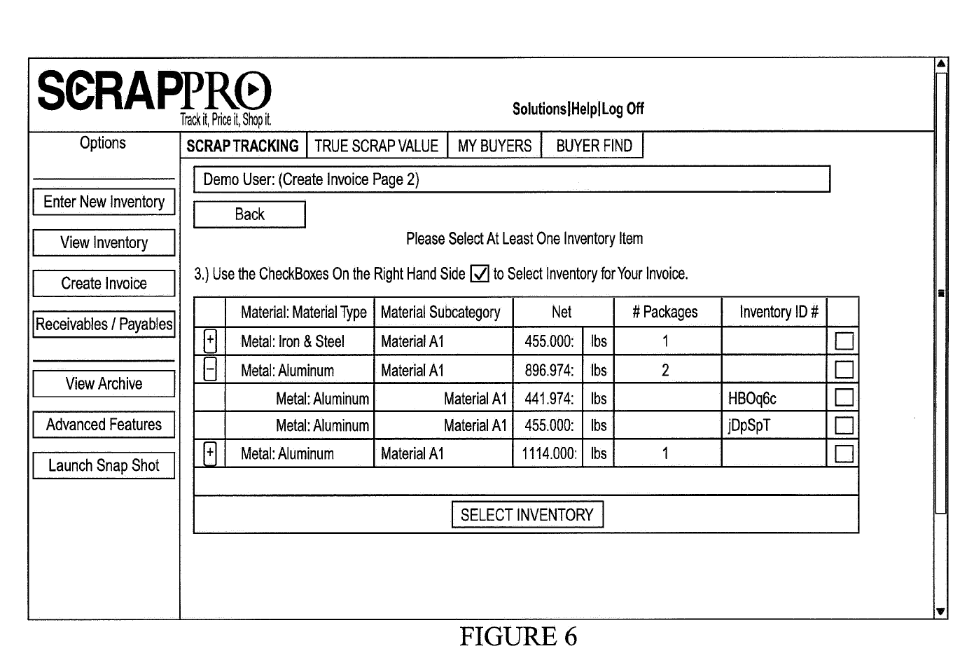

The user may then select from an inventory list as shown in FIG. 6 the inventory to be shipped. The list may be sorted or searched as described above, and may be restricted to inventory for which no invoice has been previously created. The user may select individual items from the inventory list, or select all items satisfying particular criteria.

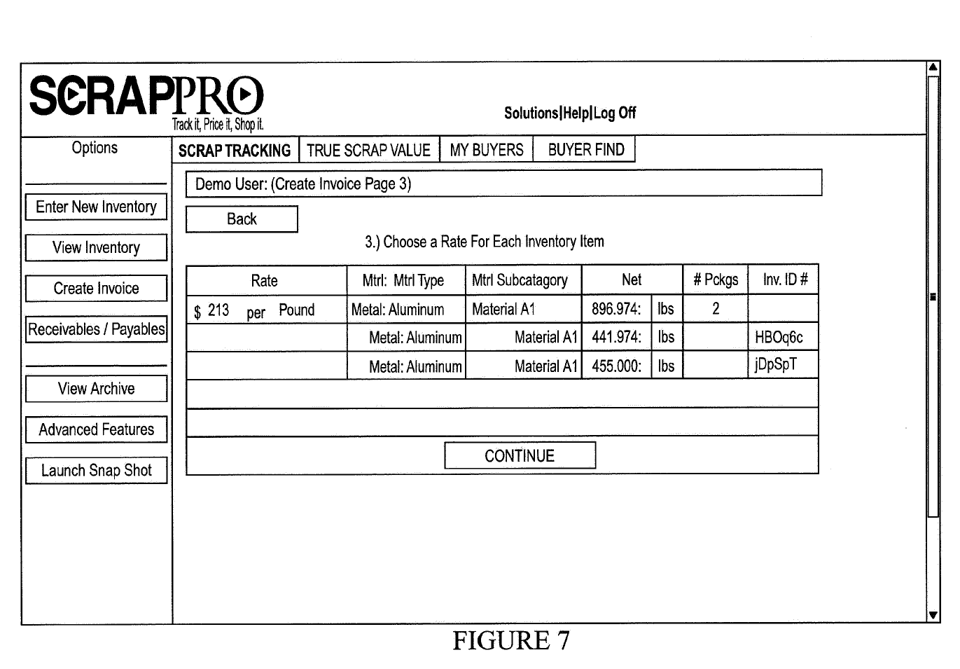

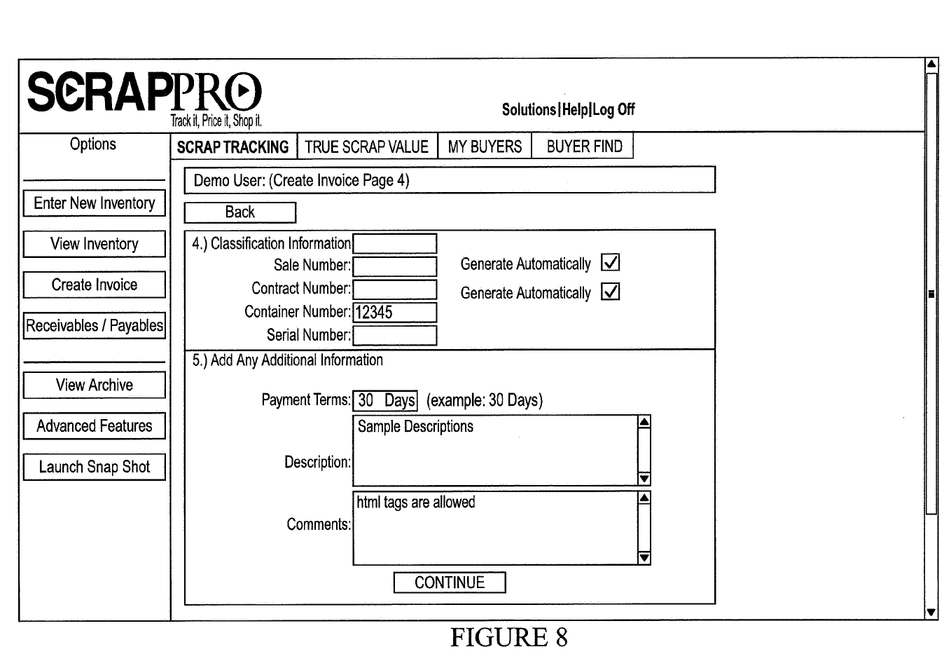

Next, the user may enter a price and weight unit for each material type as shown in FIG. 7. The user optionally may enter further identifying information, such as a sale number, contract number, container number, seal number, payment terms (e.g., days until payment due date), or other descriptions and comments as shown in FIG. 8.

The present invention then preferably calculates the total price from the weight and price information entered, as well as the payment due date based on the payment terms entered. Using the entered and calculated data, the system generates an invoice that may be saved and printed by the user.

The present invention also may be used to manage existing invoices of recyclable material. Referring again to FIG. 2, in a preferred embodiment, a user may view, resolve, or delete unresolved receivables, payables, and other transactions by clicking on a link to “Receivables/Payables” 26. After clicking that link, the user may view a list of existing invoices and sort the list based on the information described above. The system may allow the user to select a list of all receivables, all payables, all other transactions, or all transactions. The system optionally indicates past-due invoices (e.g., by using a different color font), as determined from the payment terms entered as described above. The system also optionally provides hypertext links to each invoice.

The present invention may provide a variety of options for organizing and viewing invoice information. The present invention may, for example, allow the user to sort invoices by vendor and show the total amount owed by or due to each vendor, or the total number of outstanding invoices associated with each vendor. The present invention may provide a link for each vendor leading to a list of individual invoices for a selected vendor. From the list of individual invoices, the system may provide links to show or print each invoice or its associated packing list.

The user may resolve a transaction by clicking a link for “Receive Payment,” “Make Payment,” or “Transaction Completed” (depending on whether the invoice is receivable, payable, or other, respectively). The system may also allow the entry of additional information such as the amount received, amount paid, payment type, check number, reference number, or other comments. Completed transactions may be saved in an archive for future reference.

In one preferred embodiment of the present invention, archives can be viewed, searched, and sorted in the same manner as described above for existing invoices. The system may provide access to archived invoices via a “View Archives” link. A user, for example, might view invoices for a certain vendor, for a certain invoice type, for a certain material type, or for a certain job name.

The present invention may also calculate and track the difference between invoice due dates and resolution dates, and the difference between amounts invoiced and amounts paid. The system may provide an accuracy indicator showing the difference between the total invoiced amount and the total amount received for each vendor, along with the percentage of invoiced amounts paid by the vendor. A user may examine such historical information when making transaction decisions. For example, a user may minimize credit risk by avoiding sales to buyers with a history of late payments or incomplete payments.

In one preferred embodiment, the present invention provides an “Inventory History” link from the archives page. The link provides access to a page where a user may view all inactive inventory associated with resolved invoices. The inventory may be sorted by material subcategory or job name as described above for viewing active inventory. The system may also provide for other queries and provide links to information on individual inventory items, as described above for active inventory.

One presently preferred embodiment of the invention also provides an “Advanced Features” page that allows a user to quickly manage features and settings for the entire material tracking aspect of the system. The Advanced Features page allows a user to view and delete saved material subcategories and job names. The user may also delete individual inventory items or delete all inventory items meeting specified criteria (e.g., material type). The system may also provide a “Trash Bin” from which a user may view and restore deleted items. With respect to invoices, the system may also allow the user to delete saved vendors or existing invoices.

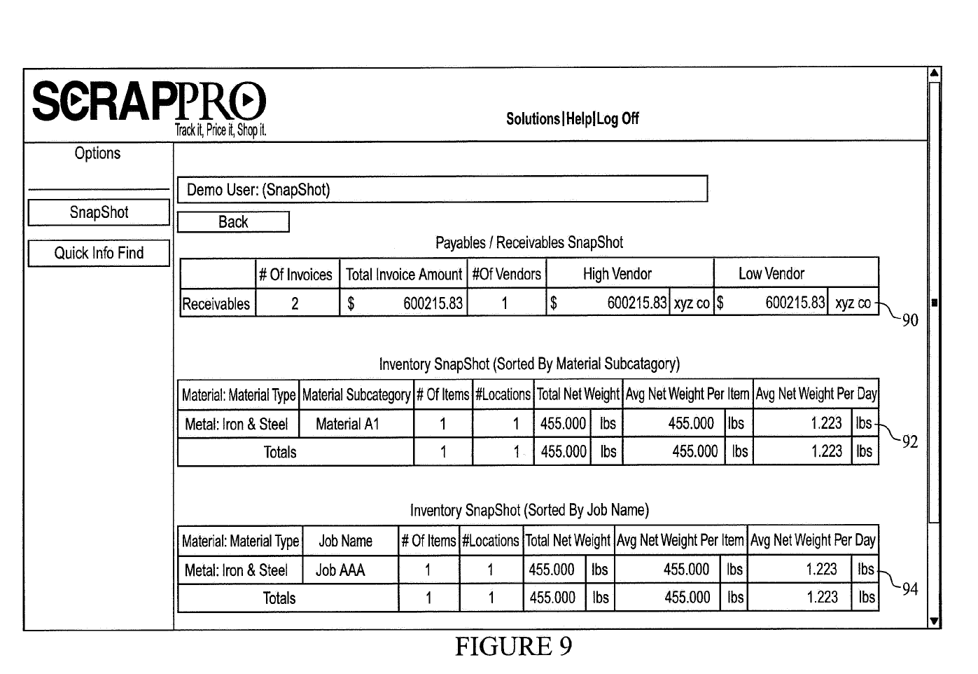

The present invention may also generate a summary of all inventory information. For example, the system may provide a “Snap Shot” page that shows various summaries pooled from all inventory data. An exemplary “Snap Shot” page Is shown in FIG. 9. The summary may include information on all active invoices, including number of active invoices, total amount of all active invoices, number of vendors associated with active invoices, and a list of vendors ranked by the amount of outstanding balance 90. Such information may also be categorized by type of invoice. The summary may also include inventory information sorted by material subcategory 92 or job name 94. Such information may include a list of materials, material types, or material subcategories associated with active inventory. The information may also include a list of job names. Other information categorized by, for example, material subcategory or job name, may include the number of active inventory items, the number of locations for active inventory items, the total net weight of active inventory items, the average net weight per inventory item, or the average net weight of inventory entered per day. The average net weight entered per day may be calculated by dividing the total net weight of active inventory by the number of days since the oldest inventory item was entered. This value may be calculated for a specified material subcategory, a specified job name, or for other specified criteria.

The present invention may also allow for customized searching and sorting of information. Active inventory, for example, may be searched or sorted by job name, material, material type, material subcategory, inventory identification number, package type, comments, gross weight, tare weight, net weight, item owner, or date first entered. Active invoices may be searched or sorted by invoice type (e.g., receivable, payable, other), vendor name, sale number, contract number, container number, seal number, description, comments, payment terms, amount due, payment due date, date first entered, or item owner. Archived invoices may be searched or sorted by invoice type (e.g., receivable, payable, other), vendor name, sale number, contract number, container number, seal number, description, initial comments, final comments, payment terms, amount due, amount paid, payment due date, date first entered, item owner, check number, payment type, or payment received date. Archived inventory may be searched or sorted by job name, material, material type, material subcategory, inventory identification number, package type, comments, gross weight, tare weight, net weight, item owner, date first entered, or invoice number. Searches and sorting may be performed for company-wide inventory, or may be limited in scope by regions or locations.

### Valuing Materials

One preferred embodiment of the present invention also provides material values, such as scrap or salvage value. Such information may be organized by material (e.g., metal, paper, plastic, glass, other), by material type, or by material subcategory. For material subcategories not currently included in the database, the present invention may allow the user to enter inquiries to be handled by a customer service representative who may personally assist the user in finding appropriate material values.

A user may utilize such material values to determine how to price materials to be sold or to evaluate offers from prospective buyers. Material values may be determined for various material types based on value history of transactions completed by various system users or through independent research.

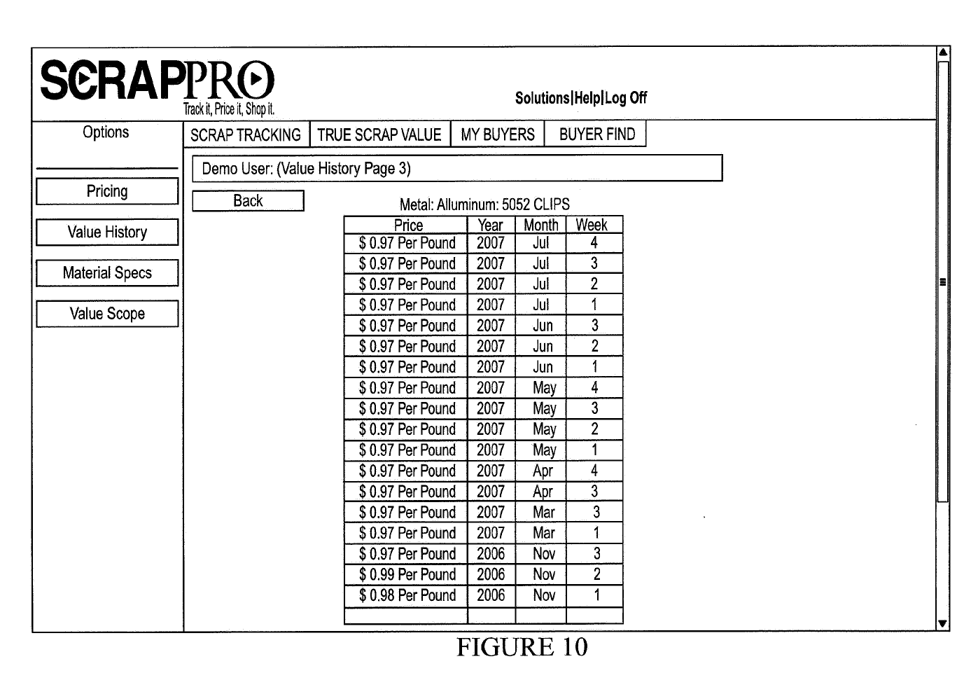

Referring again to the exemplary embodiment shown in FIG. 1, a “True Scrap Value” link 12 may be provided to access such material values. The system may allow the user to enter a material subcategory or select a material subcategory from a list of materials, followed by a list of material types for the selected material, followed by a list of material subcategories for the selected material type. The system may then provide a value for the material subcategory (in appropriate units) and a date for the material value. FIG. 10 shows an exemplary list of material values shown on a weekly basis.

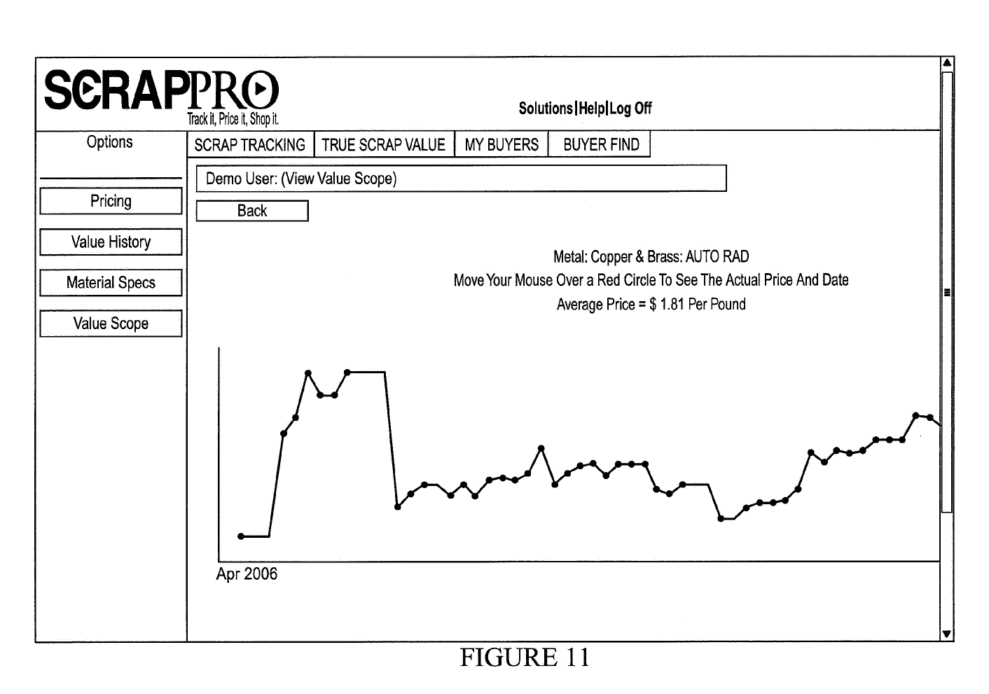

The system may also be configured to generate graphs of historical material values. A user may, for example, select a material subcategory as described above, then enter a date range. The date range may be entered by year, month, week, or day. The system may then generate a graph showing historical values for the selected material subcategory over the selected date range. The horizontal axis may span the selected date range and the vertical axis may represent the value. The graph may also be configured to display the actual value and date at various time points when the user places the mouse cursor over that time point. An exemplary graph is shown in FIG. 11.

Material values may also be tied to quality standards, and the present invention may also provide material specifications including industry quality standards, packaging guidelines, and general shipping and sales information. Such specifications may assist a user in maintaining adequate quality standards and improving customer service.

### Selling Materials

A preferred embodiment of the present invention provides users with an automated method of offering materials for sale. A user with materials for sale may employ the present invention to create invitations to bid on the materials and manage offers from vendors. Referring again to the exemplary embodiment shown in FIG. 1, the present invention may provide a “My Buyers” link 14 to a page where a user may create and manage sealed bids for materials. The system may allow a user to create bid invitations only for selected vendors. After a user selects vendors, the system generates e-mail notifications that are sent to each selected vendor. The notification may contain information such as the user company's name (i.e., the seller), pictures of the materials offered for sale, basic material information, and a link to a web page where bidding occurs. The bidding web page may include more details regarding the user and the materials offered for sale. The system may allow potential vendors to bid as many times as they like. Further, the system may allow a user to view all bids after the bidding period ends.

More specifically, the present invention may provide a “Create a Bid” link that leads to a page where a user enters bid information. The system may allow the user to select specific vendors to receive invitations. The system may allow the user to enter vendor information and save that information for future use. The system may provide a “View Vendors” page that provides a list of saved vendor information from which the user may select vendors to invite to bid. The system may also allow the user to delete vendor information that is no longer desired.

In one preferred embodiment, the system includes a “Buyer Find” link 16 that allows a user to find a buyer instead of, or in addition to, selecting specific vendors. The system may include a database of worldwide vendors. The database preferably includes information on what materials each vendor is interested in purchasing. Vendor information may be classified according to materials, material types, and material subcategories the vendor is interested in procuring or classified based on other criteria. The system may allow a user to utilize the database to find a buyer for materials. For example, instead of selecting particular vendors as described above, the user may request automatic electronic notification to all vendors interested in the particular material type offered. The system may also provide a link that allows inquiries if a user has difficulty finding a potential buyer. A customer service representative may respond to such inquiry and personally assist the user in locating a buyer.

The “Create a Bid” page may also allow a user to enter information regarding the materials for sale. Such information may include material, material type, material subcategory, description of material, a bid number (which may be automatically generated), material form (e.g., solid, turning, plate, wire, tubing, sheet, coil, other), quantity (e.g., by weight), package type, material location, preferred shipping method, bid start date, duration of time to accept bids, terms and conditions, payment terms, and other descriptions or comments. The user may optionally upload images of the materials, which may be automatically electronically stamped with the current date and bid number. The system may by default use the date of bid creation as the bid start date and automatically determine the bid end date from the duration of time to accept bids entered by the user. Alternatively, the system may allow the user to manually enter bid start and end dates.

Once an invitation to bid is created, the system automatically sends electronic notification to the vendors specified by the user or to vendors in the vendor database meeting the criteria specified by the user (e.g., vendors interested in purchasing aluminum cans). The notification may contain some or all of the information entered by the user as described above and may include a link to a web page where bidding occurs. The bidding web page may similarly include information entered by the user. The link may remain active during the duration of the bid (as defined by the bid end date).

From the bidding web page, vendors may use the system to view the bid information provided by the user and submit counteroffers for the materials. When submitting counteroffers, a vendor may enter information such as payment terms (e.g., offer price), proposed payment method, preferred shipping method, terms and conditions, contact information, whether the vendor requires an on-site inspection of the materials before purchase, or additional comments. The system may then allow a vendor to submit an offer that will be viewable by the user (i.e., seller). The system may allow a vendor to later revise an offer or submit new offers. Alternatively, the system may prevent the user from viewing any offers until the bid end date passes. The system may then provide the user with only the most recent offers submitted by each vendor.

Vendors who have not previously used the system may be asked to register with the system and be added to a vendor database. Further, the system may assign each vendor a unique username and password so that each vendor may have customized access that allows management of multiple bids in a similar manner as the system allows a user to manage inventory. The system, for example, may provide a page where a vendor may view all bids. That page may list bids by bid number, material, material type, bid start date, or bid end date. The page may also provide a link to each bid leading to the bid page where the vendor may submit offers for each bid.

The system may allow the user to view pending bids. Bids may be listed by certain information, such as bid number, material, material type, material subcategory, bid start date, or bid end date. From such a list, the system may provide hypertext links to more detailed information about each bid. The system may also allow for viewing of previous, archived bids.

The system may allow the user to separately view finalized bids (e.g., bids for which the bid end date has passed) and associated offers. The system may provide a list of bids in a similar manner as described for pending bids. The system may also allow the user to view offers submitted by vendors. The system may provide a list of offers with basic information (e.g., payment terms, payment method, shipping method, whether on-site inspection is required before purchase) and provide links to all the detailed information entered as described above by each vendor for each offer.

When a user utilizes the “Buyer Find” feature, a user's access to vendor contact information may be blocked until the user accepts an offer. Such data access restriction may be used to protect the proprietary nature of a vendor list or to prevent use of the vendor database for undesired purposes such as unsolicited advertising. When a user reviews offers, the present invention may provide a “Choose This Buyer” link for a user to accept an offer. The present invention may permit a user to select only one vendor and provide contact information for only the selected vendor.

In the case of specific vendors identified by the user in the invitation to bid, the user already has the vendor contact information and may contact the vendor directly to accept an offer.

The present invention may also allow the user to save information from completed bids and offers and later view that information by accessing a “View Archives” page. The View Archives page may contain the same information available for viewing pending and finalized bids.

The present invention accomplishes the above-described functionalities through the use of a collection of databases that are adapted to store and process information about bids, materials, and users. In addition to the databases, the present invention employs several modules (e.g., login and access module, material inventory and invoice tracking module, material valuation module, bid generation module, buyer locating module, and bid execution module) that may be implemented using programming techniques that are well-known in the art.

### Module and Database Structure

Certain presently preferred embodiments of the present invention include various databases. It is understood that the present invention may use a variety of database structures to organize data and is not limited to the structure described below.

In connection with the database descriptions below, various data fields are described. “Internal” data fields (e.g., internal identification number) refer to data fields used by source code to process user requests. Data in those data fields are preferably not viewable by a user. Those internal data fields may be used to organize and index data so that they may be properly accessed as necessary. For example, an invoice with internal identification number 456 may be associated with an inventory item with internal identification number 7849. The implementation of the present invention associates that invoice with that inventory item using the identification numbers. The present invention is not limited to embodiments containing the data fields described below.

### 1. Login and Access Module

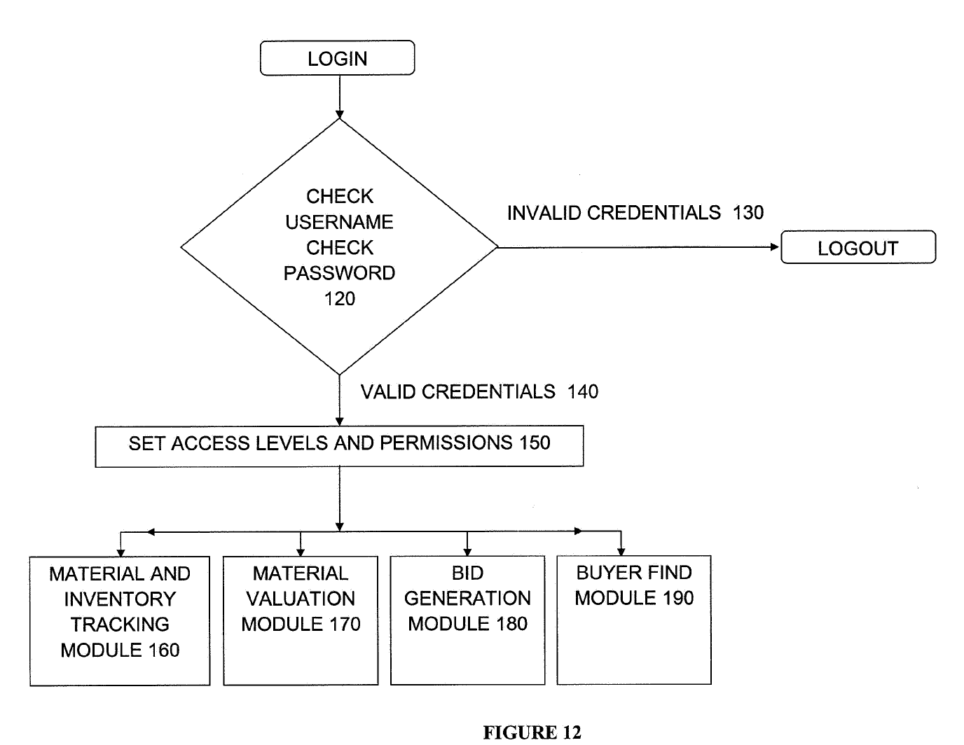

Certain presently preferred embodiments of the invention provide customized and secure access to the system by users and vendors through a login module as outlined in FIG. 12. When a user or vendor accesses the present invention, the user or vendor may be required to enter a unique username and password. The present invention then validates the username and password 120 entered by the user or vendor and denies access for invalid information 130, or allows login to the system for valid information 140. Each unique username and password combination may be associated with access levels and permissions 150 that define what data is accessible by the user or vendor. Those access levels and permissions determine which data and which modules (e.g., material and inventory tracking module 160, material valuation module 170, bid generation module 180, and buyer find module 190) the user or vendor may access.

User access to various features of the present invention may be restricted or customized by a system administrator. Access to different features may be determined, for example, through different user subscription levels. Data access may be further determined as follows: each user is assigned to a company, a region within the company, and a location within a region. There may be any number of users within a location, any number of locations within a region, and any number of regions within a company. Consequently, a user may be assigned one of four possible access levels; company, regional, location, and user. Those with company access may view data from any user, in any location, in any region. Those with regional access may view data from any user in any location within their own region. Those with location access may view data from any user within their own location. Those with user access may only view data they have entered themselves.

In a presently preferred embodiment of the invention, a variety of administrative databases are employed to store and manage information regarding user permissions and access levels. When a user logs in to the system, those databases may be accessed to determine what features and data will be accessible to the user.

A user database contains user name and password data for each user. Data fields in the user database may include: internal identification number, user e-mail address, user password, internal classification, internal location identification number, internal user contact information profile identification number, internal company contact information identification number, internal region contact information identification number, internal swap space for computation, and various data fields indicating the date and time of last e-mail, password update, or login.

The present invention may also include a location database containing the name of each location. The location database may include various data fields, including: internal identification number, location name, internal location access options identification number, internal region identification number, internal company contact information identification number, internal classification, and various data fields indicating the last update to location contact information.

A location access database may contain access information for each location. The location access database's data fields may include: internal identification number, name for location access options, access status for regional financial information, whether a location has permission to access user and company data, access level for this user, access status for general financial information, access status for creating invitations to bid using “Buyer Find” feature, access status for creating invitations to bid by specifying vendors, various data fields related to access status to various material value and material specification data, access status to inventory and invoice tracking, access status to archived bids and offers, access status for uploading pictures when creating bids, access status for freight quotes, access status for sending e-mails, access status for credit reporting services, access status for vendor advertising, access status for user advertising, access status for insurance, access status for escrow services, and various data fields indicating the date and time access options were last updated.

A location profile database may contain contact information for each location, contained in data fields such as: internal identification number, location name, address for location (may be divided into multiple fields for multiple address lines), city for location, state for location, ZIP code for location, country for location, phone number for location, fax number for location, and various data fields indicating the date and time location contact information was last updated.

A region database may store data related to payment information for each region. The region database may include data fields for: internal identification number, region name, internal region pay period identification number, internal region contact information identification number, internal company contact information identification number, payment method, internal classification, various fields for credit card information (e.g., credit card type, credit card number, card holder name, credit card expiration date), various fields for bank information (e.g., bank name, bank routing number, bank account number, bank account owner name), total payments made, and various data fields indicating the date and time of last payment, next payment, and last payment information update.

A region profile database may contain contact information for each region, and may include data fields such as: internal identification number, region name, address for region (may be divided into multiple fields for multiple address lines), city for region, state for region, country for region, ZIP code for region, phone number for region, fax number for region, and various data fields indicating the date and time region contact information was last updated.

A region options database may contain billing period information for each user. The region options database may contain data fields including: internal identification number, pay period name, pay period duration (may be divided into multiple fields for different units of time, such as years, months, weeks, days), payment amount per pay period, and various data fields indicating the date and time pay period information was last updated.

A company profile database may contain company general information. The company profile database may include data fields for: internal identification number, company name, subscription level, internal classifications, address for company (may be divided into multiple fields for multiple address lines), city for company, state for company, ZIP code for company, country for company, phone number for company, fax number for company, number of employees for company, gross annual sales for company, sign up code for company, various data fields indicating the date and time a company's subscription begins and company contact information was last updated.

A login log database may exist for administrative purposes and may store information for all successful logins. The login log database may include data fields such as: internal personal identification number, date and time of login, IP address of computer used to login, domain name of computer used to login, browser used on computer used to login, MIME types used on computer used to login, country where IP address is registered, language used on computer used to login, cookie placed on user's computer, and HTTP request method.

A beta users database may store information regarding “beta users,” who do not have access to proprietary data (e.g., material values, material specifications, vendor lists) contained in the system. Beta users may be users using the system, for example, on a demonstration or trial basis. The beta users database may include data fields such as: internal identification number, company contact information identification number, internal swap space for computation, whether terms and conditions have been signed, identification number of user agreeing to terms and conditions, date when terms and conditions were signed, internal classification, and access level (e.g., beta or regular user).

A user profile database may contain contact information for each user. Data fields in the user profile database may include: internal identification number, user's name (may be divided into first name and last name fields), various data fields for contact information (e.g., address (may include multiple fields for multiple address lines), city, state, country, ZIP code, phone number (may include multiple fields for multiple phone numbers), phone extension (may include multiple fields for multiple phone numbers), fax number, professional position/title, and various data fields indicating the date and time of last contact information update.

The present invention may also contain a variety of other similar databases containing lists of users with access to specified functionalities of the present invention (e.g., users with access to the “Snap Shot” feature, users whose access is restricted to the “Buyer Find” feature, users whose access is restricted to material values and specifications).

### 2. Material Inventory and Invoice Tracking Module

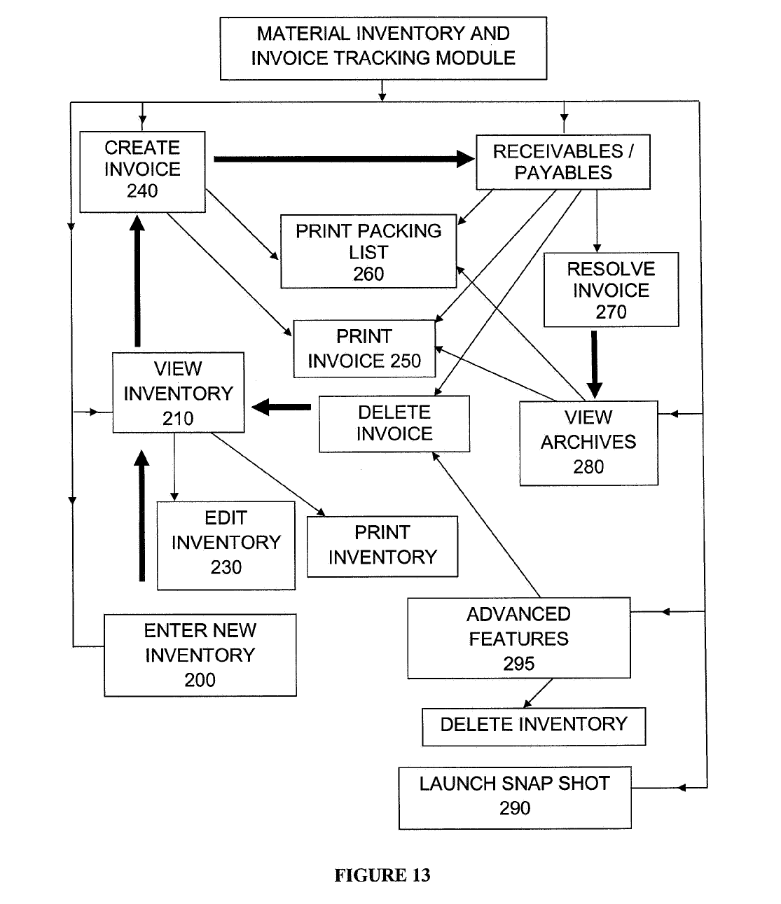

At least one preferred embodiment of the present invention includes a material inventory and invoice tracking module in the form shown in FIG. 13. A user may enter new inventory 200. Once inventory data is stored by the present invention, a user may view inventory 200 and print 220 or edit 230 inventory data. A user may also create 240 and print an invoice 250 and packing list 260 for inventory items. A user may view invoice data or resolve invoices 270. Data associated with resolved invoices and associated inventory may be stored in an archives, and a user may view 280 or print that inventory or invoice data. Inventory and/or invoice data may be viewed on a “Snap Shot” page 290 as previously described. Further, a user may access “Advanced Features” 295 as previously described.

An inventory database contains various data fields to store various data related to inventory items. Those data fields may include: internal identification number, job name, material, material type, company identification number for the user who entered inventory, regional identification number for the user who entered inventory, location identification number for the user who entered inventory, personal identification number for the user who entered the inventory, internal identification number associating inventory with an invoice, internal classification number for inventory, inventory identification number, gross weight, tare weight, net weight, units for gross weight, units for tare weight, units for net weight, package type, internal inventory classification relating to invoice, comments, and various fields indicating the date and time inventory was entered or last edited. New inventory data entered by a user may be stored in the inventory database. The present invention may access data in the inventory database when a user wishes to view, edit, print, delete, organize, search, or create inventory or invoices.

An invoice database may contain various data fields that store data from invoices. Those data fields may include: internal identification number, company identification number for the user who created an invoice, regional identification number for a user who created an invoice, subgroup identification number for the user who created an invoice, personal identification number for the user who created an invoice, internal classification of invoice, swap space for internal computation, sale number, contract number, total monetary amount due, external invoice classification (e.g., payable, receivable, other), vendor company name, various data fields related to vendor contact information (e.g., company contact person name (may be divided into separate fields for first and last names), address (may be divided into multiple fields for multiple address lines), phone number, fax number, e-mail address), container number, seal number, description, payment due date, invoice resolution date, payment terms, comments, payment type, check number, reference number, amount paid/received, and various data fields indicating the date and time an invoice was created. The present invention may store data in the invoice database when a user generates new invoices or packing lists, and may access the invoice database when a user wishes to view, print, delete, or resolve invoices or packing lists.

An invoice rates database may exist as an extension to the invoice database. An invoice rates database may contain various data fields to store additional invoice data created when an invoice contains multiple rates (i.e., prices) and inventory items. Such data fields may include: internal identification number, internal identification number associated with an invoice, internal classification, swap space for internal computation, price, weight units, material, material type, material subcategory, and various data fields indicating the date and time an invoice was created. The present invention may store data in the invoice rates database when a user generates new invoices or packing lists, and may access the invoice rates database when a user wishes to view, print, delete, or resolve invoices or packing lists.

A job name database may contain various data fields to store data related to saved job names associated with inventory. Such data fields may include: internal identification number, company identification number for the user who entered inventory, region identification number for the user who entered inventory, location identification number for the user who entered inventory, personal identification number for the user who entered inventory, internal classification, job name, and various fields indicating the date and time inventory was entered or last edited. The present invention may store data in the job name database when a user enters a job name associated with inventory. The job name database may be accessed when a user wishes to view, print, delete, or edit job names, or when a user wishes to create a new inventory item using a saved job name.

A material subcategory database may exist to store data related to saved material subcategories associated with inventory. A material subcategory database may include data fields such as: internal identification number, company identification number for the user entering inventory, region identification number for the user entering inventory, location identification number for the user entering inventory, personal identification number for user entering inventory, internal classification, material subcategory, and various fields indicating the date and time inventory was entered or last edited. Data may be entered into the material subcategory database when a user creates a new material subcategory (e.g., when entering a new inventory item). The present invention may access the material subcategory database when a user wishes to view, print, delete, or edit material subcategories, or when a user wishes to create a new inventory item using a saved material subcategory.

Another possible database for inclusion in the present invention is a vendor database to store vendor information related to invoices. Data fields in a vendor database may include: internal identification number, company identification number for the user creating an invoice, region identification number for the user creating an invoice, location identification number for the user creating an invoice, personal identification number for the user creating an invoice, internal classification, vendor company name, various data fields related to vendor contact information (e.g., company contact person name (may be divided into separate fields for first and last names), address (may be divided into multiple fields for multiple address lines), phone number, fax number, e-mail address), and various data fields indicating the date and time an invoice was created. Data may be stored in the vendor database when a user enters new vendor information (e.g., when creating an invoice). The present invention may access the vendor database when a user wishes to view, print, delete, or edit vendor information, or when a user wishes to create an invoice using saved vendor data.

### 3. Material Valuation Module

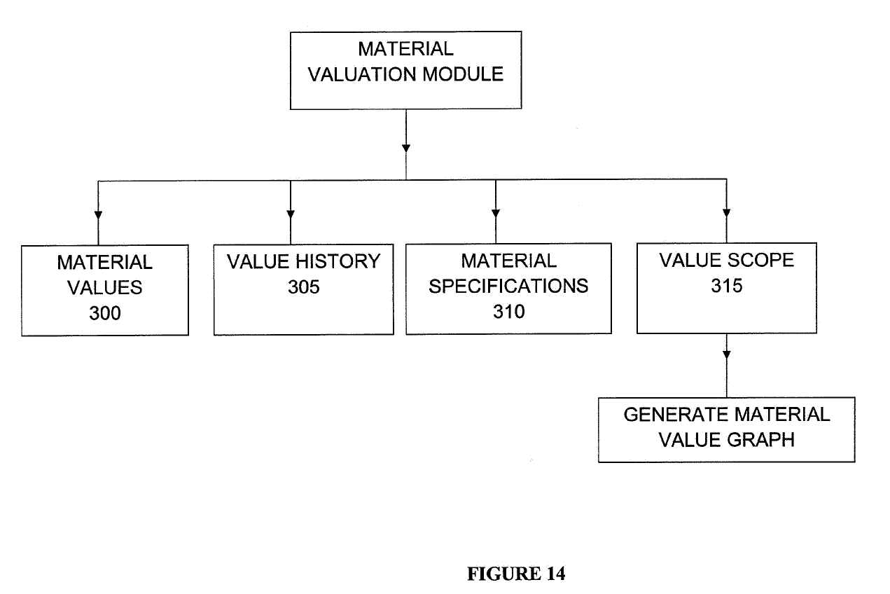

A material valuation module preferably has a structure as shown in FIG. 14. The material valuation module includes components for material value information 300, historical value information 305, material specifications 310, and creating graphs of historical value information 315.

A pricing material subcategory database may contain data on material subcategories for which material value and material specification information is available. Data fields in the pricing material subcategory database may include: internal identification number, internal identification number for the associated material, internal identification number for the associated material type, internal classification, whether the subcategory is publicly available to all users, material subcategory name, material specifications for the subcategory, internal swap space for computing, identification number for administrator entering subcategory, identification number for administrator editing subcategory, and various data fields indicating the date and time the subcategory was entered or edited. Data may be entered into the pricing material subcategory database by a system administrator, and access may be restricted to such administrators. Users may access the data when requesting and viewing material specifications or material value data.

A related prices database may contain material value information associated with material subcategories. The prices database may include data fields such as: internal identification number, internal identification number for associated material, internal identification number for associated material type, internal classification, name of material subcategory, price, price units, internal swap space for computing, identification number for administrator entering price, identification number for administrator editing price, and various data fields indicating the date and time the price was entered or edited. Data may be entered into the prices database by a system administrator, and access may be restricted to such administrators. Such data may be based on independent research. Users may access the data when requesting and viewing material specifications or material value data.

At least one preferred embodiment of the present invention also includes a graph file names database to store file names for graphs of historical material value information generated when a user requests such graphs as described above. The graph file names database may include data fields for: internal identification number, file name for graph, internal swap space for computation, and date graph was created. The graph file names database may be accessed and updated when a user requests a graph of historical material value information.

### 4. Bid Generation and Buyer Find Modules

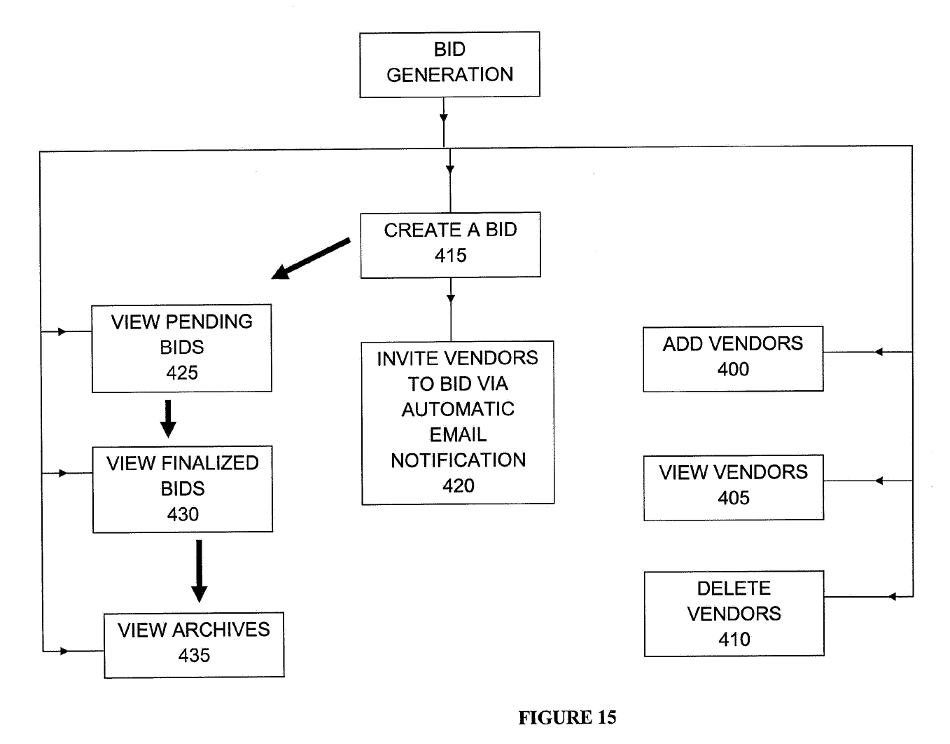

As previously described, a user may create a bid and invite vendors known to the user. The bid generation module for this functionality is schematically represented by FIG. 15. A user may add 400, view 405, or delete 410 vendor data stored by the system. A user may create a bid 415 as previously described and invite selected vendors to bid 420. A user may view pending 425, finalized 430, and archived bids 435.

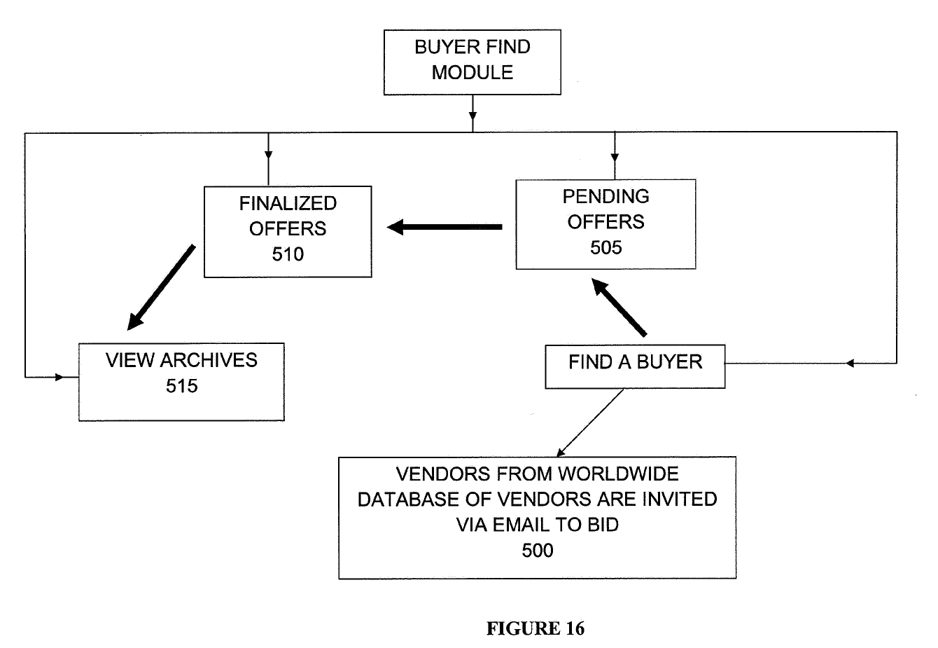

A user may alternatively use the previously described “Buyer Find” feature. An exemplary module for the Buyer Find feature is illustrated in FIG. 16. As previously described, the present invention identifies potential vendors based on criteria entered by a user and sends to those vendors an e-mail invitation to bid 500. A user may view pending 505, finalized 510, and archived bids 515.

A bid database may contain general data related to each bid created by a user. The bid database may include data fields such as: internal identification number, company identification number for the user creating a bid, region identification number for the user creating a bid, location identification number for the user creating a bid, personal identification number for the user creating a bid, internal classification, internal swap space for computation, bid number, preferred shipping method, time to accept offers, various location data fields (e.g., city, state, ZIP code, region of state, country), material description, terms and conditions, payment terms, bid start date, bid end date, and various data fields indicating the date and time the bid was created. Data in the bid database may be updated when a user creates a bid or processes a finalized bid. The bid database may be accessed when a user views, prints, or deletes bids or offers, or when a vendor views or prints bid information.

A bid material database may contain data related to the material associated with each bid. Data fields in the bid material database may include: internal identification number, company identification number for the user creating a bid, region identification number for the user creating the bid, location identification number for the user creating the bid, personal identification number for the user creating the bid, internal classification, internal swap space for computation, internal identification number for general bid information, internal identification number for material, internal identification number for material type, material, material type, material subcategory, specific material type, material form, package type, estimated quantity, estimated quantity weight units, bid start date, bid end date, and various data fields indicating the date and time the bid was created. The bid material database may be accessed when a user views, prints, or deletes bids or offers, or when a vendor views or prints bid information.

The present invention preferably also includes a vendor database associated with bids, containing data fields substantially similar to those described above for the vendor database for vendor data related to invoices. The bid vendor database may be updated when a user adds or deletes vendors, and may be accessed when a user creates, views, or prints a bid, or views or prints offers. The bid vendor database may also be accessed when a vendor views bid information.

An offer database may contain data entered by vendors when making offers in response to invitations to bid. The offer database may include data fields such as: internal identification number, internal bid identification number, internal vendor identification number, internal classification, internal swap space for computation, total price offered, price units for total price offered, payment method, preferred shipping method, whether the vendor requires on-site inspection prior to purchase, payment terms, terms and conditions, comments, and various data fields indicating the date and time the offer was created or edited. The offer database may be updated when a vendor creates an offer. The offer database may be accessed when a user or vendor views or prints offers.

A buyer identification key database contains access security key information for vendors. Data fields in the buyer identification key database may include: internal identification number, internal bid identification number, internal vendor identification number, internal vendor identification number, internal user identification number, bid security key (may be randomly generated), vendor security key (may be randomly generated), internal classification, internal swap space for computation, number of times a vendor has accessed an associated bid, date bid was created, and date bid expires. Data in the buyer identification key database may be updated when the system sends e-mail notification to vendors of a bid created by a user, when a vendor wishes to access bid information, and when a finalized bid is processed. Data in the buyer identification key database is accessed when a vendor wishes to access bid information.

A dynamic picture file name database stores dynamically generated file names for pictures of inventory items uploaded by users. The dynamic picture file name database may include data fields such as: internal identification number, internal bid identification number, internal classification, internal swap space for computation, dynamically generated file name for user-uploaded picture, and date associated bid was created. Data in the dynamic picture file name database may be updated when a user uploads pictures (e.g., when creating a bid) or when a user processes a finalized bid. The dynamic picture file name database may be accessed when a user or vendor views bid information. Similarly, an original picture file name database stores original file names for pictures of inventory items uploaded by users. The original picture file name database contains data fields similar to those described in the dynamic picture file name database, except the dynamically generated file name field is replaced with an original file name field. The original picture file name database may be accessed and updated when a user uploads pictures (e.g., when creating a bid).

Data contained in the various databases described herein may be associated in a variety of manners. The present system may use the internal identification numbers described above to associate data from one database with data in other databases. When a buyer chooses to use the “Buyer Find” feature, geographic information, desired price range, or desired material subcategories associated with a vendor may serve as the basis for a match for a quantity of material offered by a user in a bid. Through such mechanisms, the information that a vendor submits may then be associated to data in the corresponding bid database to identify potential buyers.

Nothing in the above description is meant to limit the present invention to any specific organization of elements. Many database/module substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A method for managing volumes of materials throughout a complete recyclables lifecycle, comprising the steps of:
storing data regarding a quantity of material;
organizing said data;
acquiring values or costs and grade specification data relevant to said quantity;
selecting a vendor to bid on said quantity;
generating an invitation to bid on said quantity;
reviewing an offer to purchase said quantity; and
accepting an offer to purchase said quantity.

2. The method of claim 1, wherein said step of storing data comprises entering data via an interface with an electronic device.

3. The method of claim 1, further comprising the step of:
creating an invoice for said quantity.

4. The method of claim 1, wherein said step of selecting a vendor to bid comprises the steps of:
identifying a classification for said material; and
selecting based on said classification a vendor from a database, said database containing information regarding a purchasing disposition of said vendor.

5. A method for managing quantities of materials, comprising the steps of:
receiving data regarding a quantity of material;
receiving data regarding potential buyers for said quantity;
communicating an invitation to purchase said quantity from a user to said potential buyers;
receiving data regarding offers to purchase said quantity from said user; and
transmitting said data regarding offers to purchase to said user.

6. The method of claim 5, further comprising the step of:
using said data regarding a quantity of material and said data regarding offers to purchase to generate an invoice for said quantity.

7. The method of claim 5, wherein said material is a recyclable material.

8. The method of claim 7, wherein said recyclable material is selected from the group consisting of metal, glass, paper, and plastic.

9. A system for managing volumes of materials, comprising:
a database containing attributes of a plurality of inventory materials;
a first browser-based interface adapted to allow a user to view and search said attributes; and
a second browser-based interface adapted to allow said user to create an invoice utilizing said attributes.

10. The system of claim 9, wherein said attributes are selected from the group consisting of material, material type, material subcategory, job name, package type, gross weight, tare weight, net weight, and inventory identification number.

11. The system of claim 9, further comprising:
a second database containing material values for a plurality of materials;
a third browser-based interface adapted to allow said user to access said material values.

12. The system of claim 11, wherein said third browser-based interface is further adapted to allow generation of graphical representations of said material values.

13. The system of claim 11, wherein said material values includes historical material values.

14. The system of claim 9, further comprising:
a second database containing vendor data; and
means for inviting a vendor to bid, wherein said vendor data includes criteria indicating a purchasing disposition of said vendor.

15. The system of claim 9, further comprising:
a third browser-based interface adapted to allow said user to invite a vendor to bid on one of said plurality of inventory materials.

16. The system of claim 15, further comprising:
a fourth browser-based interface adapted to allow said vendor to make offers to purchase said one of said plurality of inventory materials.

17. The system of claim 9, further comprising:
a database containing attributes of invoices created using said second browser-based interface.

18. The system of claim 17, wherein said attributes of invoices are selected from the group consisting of: sale number, contract number, amount due, user, user company name, user region, user location, vendor company name, vendor contact information, container number, seal number, description, payment due date, invoice resolution date, payment terms, comments, payment type, check number, amount paid, amount received, and date of invoice creation.

19. The system of claim 9, further comprising:
a login and access module adapted to provide secure and customized access to said system.

20. The system of claim 9, further comprising:
a second database containing material specifications data.
